(19) United States
(12) Patent Application Publication
(10) Pub. No.: US 2026/0320079 A1
(43) Pub. Date: Oct. 15, 2026

(54) System and Method for Perspective-Anchored Structural Coherence Classification with Non-Resolution Constraints

(71) Applicant: Jody Rahsaan Jones, Queens, NY (US)

(72) Inventor: Jody Rahsaan Jones, Queens, NY (US)

(21) Appl. No.: 19/539,277

(22) Filed: Feb. 13, 2026

(51) Int. Cl. G06F 16/28

(52) U.S. Cl. CPC G06F 16/285

(57) ABSTRACT

A coherence assessment architecture is disclosed that classifies structural alignment and misalignment among encountered epistemic records without asserting truth, validity, reliability, credibility, or consequence. Coherence evaluation is present-anchored and perspective-bound, limited to records visible at a canonical present, and supports categorical coherence states including partial, fragmented, and underdetermined conditions, while preserving incoherence as a first-class diagnostic outcome. Coherence records are append-only, immutable, and read-only and are prohibited from gating access, altering encounterability, conditioning eligibility, triggering action, prioritizing processing, or influencing downstream behavior. Coordinated enforcement of these constraints produces a system-level effect of inconsistency without resolution, enabling diagnostic visibility without authority, enforcement, or control.

### 1. TECHNICAL FIELD

### 1.1 Structural Coherence Assessment Systems

The present invention relates to computational architectures for structural coherence assessment within complex, multi-layered systems. More specifically, it concerns architectures that classify internal alignment and misalignment among recorded epistemic structures without interpreting semantic meaning, asserting truth or correctness, inferring reliability, or resolving outcomes.

Structural coherence assessment addresses how independently formed records, including events, references, or statements, relate to one another with respect to internal structural consistency at a given present. Such assessment operates only over what is visible to an assessing perspective and evaluates alignment as a property of structure rather than as a claim about factual accuracy, evidentiary strength, or validity.

The present invention applies to environments in which multiple epistemic records coexist, potentially with partial, fragmented, or conflicting structure, and in which coherence must be described without privileging, prioritizing, suppressing, discarding, or resolving any record.

### 1.2 Non-Normative Consistency Classification

The present invention further pertains to non-normative consistency classification, in which coherence is treated as a descriptive diagnostic property rather than as a standard of acceptability, correctness, trustworthiness, or authority.

Under the disclosed architecture, consistency and inconsistency are classified without normative interpretation. Coherence does not imply truth, factual accuracy, reliability, credibility, priority, or evidentiary weight, and incoherence does not imply falsehood, error, fault, invalidity, or exclusion.

Consistency classification answers only whether structural elements align under declared coherence rules, and does not judge whether records should be believed, accepted, preferred, retained, acted upon, or resolved. By explicitly denying normative and priority semantics, the invention prevents coherence assessment from becoming a proxy for moderation, validation, ranking, attention allocation, or decision-making.

### 1.3 Authority-Safe Diagnostic Layers

The present invention also relates to authority-safe diagnostic layers, defined as architectural layers that expose analytical classifications without exerting control over system behavior.

Within such layers, coherence assessments are read-only diagnostics. They do not gate access, alter encounterability, constrain admissibility, modify relational force, influence continuity or persistence, trigger actions, or prioritize processing. Diagnostic outputs may be inspected, audited, logged, or visualized, but they do not instruct downstream systems how to behave.

By structurally denying authority at the coherence layer, the invention ensures that increased diagnostic visibility does not translate into increased governance power. Coherence assessment remains a mechanism for exposing structural relationships, not for enforcing order, resolving inconsistency, assigning blame, or compelling alignment.

### 2. BACKGROUND AND FAILURE MODES

### 2.1 Collapse of Coherence Into Truth or Validity

In many systems, coherence assessment is implicitly treated as a proxy for truth, correctness, or validity, such that records that align with one another are presumed accurate or acceptable, while records that conflict are presumed erroneous or defective.

This collapse conflates internal alignment with correspondence to reality. Coherence describes how structures relate to each other, not whether any structure is true. Systems that equate coherence with validity elevate consistency into epistemic authority, allowing internally aligned falsehoods to appear credible and internally inconsistent truths to be discounted. The present invention addresses this failure by structurally separating coherence classification from all claims of truth or correctness.

### 2.2 Suppression or Filtering of Incoherent Material

Another common failure mode occurs when incoherent material is suppressed, filtered, excluded, or deprioritized based on coherence assessment.

Such use transforms coherence from a diagnostic mechanism into a filtering or enforcement tool. Instead of exposing inconsistency, the system erases it, preventing inspection and obscuring the epistemic landscape. Suppression collapses diagnostic assessment into control and denies downstream processes access to the very inconsistencies that coherence analysis is meant to reveal. The present invention requires that incoherent material remain visible and classifiable, rather than suppressed or excluded.

### 2.3 Consistency-as-Reliability Assumptions

Many systems treat consistent records as inherently reliable, trustworthy, or credible, interpreting repetition, mutual reinforcement, or lack of contradiction as evidentiary strength.

This assumption is architecturally unsound. Consistency may arise from shared bias, coordinated error, or incomplete visibility, while inconsistency may arise from partial information, evolving knowledge, or perspective differences. Treating consistency as reliability introduces normative judgment into what should be a descriptive layer. The present invention explicitly denies any inference of reliability, trustworthiness, or evidentiary weight from coherence or consistency.

### 2.4 Global or Omniscient Coherence Models

A further failure arises when coherence is assessed using global or omniscient models that assume access to all relevant records or perspectives.

Such models evaluate coherence against an idealized totality rather than against what is actually visible to a given perspective at a given present, collapsing agent-relative visibility into an imagined global truth space and enabling retroactive judgment when new information becomes available. The present invention rejects global coherence by requiring that coherence assessment be perspective-anchored and constrained to the set of records visible to the assessing perspective at the present moment.

### 2.5 Retroactive Rewrite of Coherence History

In some architectures, coherence assessments are revised, overwritten, or “corrected” as new records appear or as interpretation evolves, replacing earlier assessments with updated conclusions.

This retroactive rewrite destroys historical fidelity, making it impossible to inspect what was coherent or incoherent at an earlier time and allowing present judgments to reshape past records. Such mutation collapses descriptive assessment into narrative reconstruction. The present invention prohibits retroactive modification of coherence records, permitting new assessments to be added while requiring prior assessments to remain intact.

### 2.6 Gating and Enforcement via Coherence Signals

Finally, coherence signals are often used to gate access, trigger enforcement, or prioritize action, such that records deemed coherent are promoted while records deemed incoherent are demoted, blocked, or penalized.

This use converts diagnostic output into control input, making coherence a lever for governance under the guise of structural assessment. The present invention categorically prohibits the use of coherence assessment to gate, trigger, prioritize, suppress, or enforce system behavior, ensuring that coherence remains descriptive, non-authoritative, and non-influential.

### 3. PURPOSE AND SCOPE OF THE INVENTION

### 3.1 Purpose of Descriptive Coherence Assessment

The purpose of the present invention is to provide descriptive coherence assessment as a structural diagnostic capability that classifies alignment and misalignment among epistemic records without asserting truth, validity, reliability, priority, or consequence.

Descriptive coherence assessment answers a limited structural question: how do visible records relate to one another in terms of internal consistency at a given present. It does not answer whether any record is correct, acceptable, trustworthy, authoritative, or worthy of action. By constraining coherence to description rather than judgment, the invention enables systems to expose inconsistency without resolving it and to reveal alignment without endorsing it.

This purpose restores coherence to its proper role as an explanatory diagnostic tool rather than a decision-making instrument. Coherence becomes a way to understand structural relationships, not a mechanism for controlling outcomes, suppressing disagreement, or enforcing agreement.

### 3.2 Scope of Non-Normative, Non-Decisional Classification

The scope of the present invention is limited to non-normative, non-decisional classification of coherence.

Within this scope, coherence assessment does not validate or invalidate records, does not infer truth, correctness, reliability, credibility, or evidentiary strength, does not suppress, filter, exclude, or deprioritize incoherent material, does not gate access or alter encounterability, does not trigger action or consequence, and does not rank, score, or prioritize records.

Coherence classifications are categorical and descriptive and may indicate alignment, misalignment, partial coherence, fragmentation, or underdetermination, but they carry no evaluative, prescriptive, or normative meaning. Incoherence is treated as a first-class diagnostic state, not as an error, defect, or failure to be corrected or removed.

Any normative interpretation or use of coherence, including deciding what to trust, what to ignore, what to retain, or what to act upon, must occur only downstream under explicitly assumed authority and must not be attributed to, inferred from, or enforced by the coherence assessment layer itself.

### 3.3 Relationship to the Non-Collapse Architectural Stack

The coherence assessment architecture disclosed herein operates as a diagnostic layer within the non-collapse architectural stack, positioned downstream of existence registration and informational measurement and upstream of evaluation and action.

Within this stack, epistemic boundary formation establishes what exists without judgment, informational measurement exposes structure without leverage, relational force geometry constrains possibility without governance, communicative routing governs admissibility without consent inference, coherence assessment classifies alignment without resolution, evaluation observes without deciding, and action occurs only through explicit external authority.

The present invention supplies visibility into consistency without permitting that visibility to become control. Coherence records are perspective-anchored, append-only, and read-only, and must not modify or reinterpret upstream existence, measurement, or force constraints, nor may they influence downstream evaluation, prioritization, or execution.

By enforcing this position and scope, the invention preserves the non-collapse invariant that no layer may silently acquire authority over another. Coherence assessment explains inconsistency without resolving it, ensuring that understanding does not become enforcement and that diagnostic clarity does not collapse into governance.

### 4. PERSPECTIVE-ANCHORED COHERENCE EVALUATION

### 4.1 Present-Anchored Assessment (CSRₖ)

Coherence assessment under the present invention is anchored to a canonical present (CSRₖ). Each coherence evaluation is computed relative to a specific canonical state reference and reflects alignment and misalignment among records as they are visible at that present only. Coherence assessment does not span across canonical presents, does not interpolate past or future states, and does not assume continuity, persistence, or evolution beyond what is explicitly recorded at CSRₖ.

By anchoring coherence to CSRₖ, the invention prevents temporal smearing and retroactive judgment. A record that is incoherent at one present may be coherent at another, and such differences are preserved through append-only coherence records rather than reconciled, corrected, or overwritten.

Present anchoring ensures that coherence remains a snapshot diagnostic, not a temporal verdict, forecast, or cumulative assessment.

The canonical present (CSRₖ) is a formally defined state reference established by the canonical state authority layer of the architectural stack and represents the complete set of records encounterable to the assessing perspective at that reference.

Coherence assessment must not interpolate across canonical state references or assume visibility beyond that defined by CSRₖ.

### 4.2 Agent-Relative Visibility Constraints

Coherence assessment under the present invention is agent-relative and constrained by what is visible to the assessing perspective.

The set of records considered in a coherence evaluation consists only of those records that are encounterable or encountered by the agent at the canonical present. Records that exist canonically but are not visible, accessible, or encounterable to the agent at CSRₖ must not be included in the coherence assessment.

This constraint explicitly denies omniscience. Coherence is evaluated over what is seen, not over what exists globally. Different agents possessing different visibility sets at the same present may therefore produce different coherence classifications without contradiction, error, or inconsistency.

By enforcing agent-relative visibility, the invention ensures that coherence reflects perspective-bound structural relationships rather than an imagined global or objective consistency space.

### 4.3 Coherence of Encountered Structure Only

Coherence assessment under the present invention applies only to encountered structure, and not to hypothetical, inferred, predicted, or inaccessible records.

The architecture prohibits coherence computation over records not yet encountered, records inferred from other records, records outside the agent's access window, or records that exist canonically but are not visible at CSRₖ.

Coherence assessment must be grounded exclusively in explicit, encountered structure and must not anticipate future encounters, reconstruct past omissions, infer hidden consistency, or speculate about unobserved records.

By restricting coherence to encountered structure only, the invention prevents coherence assessment from becoming speculative, predictive, or reconstructive and ensures that coherence remains a faithful diagnostic of actual exposure, not an instrument of inference or foresight.

### 5. COHERENCE CLASSIFICATION WITHOUT RESOLUTION

### 5.1 Structural Alignment and Misalignment Categories

The coherence assessment architecture classifies structural alignment and misalignment using categorical descriptors that indicate how encountered records relate to one another under explicitly declared coherence rules.

Alignment categories describe configurations in which encountered records are mutually consistent with respect to declared structural constraints, while misalignment categories describe configurations in which records exhibit contradiction, incompatibility, or non-alignment under those same constraints.

These categories are descriptive labels rather than judgments. They do not indicate correctness, preference, reliability, credibility, or acceptability, and do not imply that aligned records are true or that misaligned records are false. They record only the presence or absence of structural consistency among encountered records at the present.

Coherence categories are finite, explicitly declared, and applied deterministically, and must not be learned, weighted, ranked, optimized, or adapted based on outcomes, usage patterns, or downstream application.

### 5.2 Partial, Fragmented, and Underdetermined Coherence

The present invention explicitly supports partial, fragmented, and underdetermined coherence states as first-class diagnostic outcomes.

Partial coherence describes situations in which some encountered records align while others do not, fragmented coherence describes situations in which alignment exists only within disjoint subsets of records without global consistency, and underdetermined coherence describes situations in which available structure is insufficient to establish alignment or misalignment conclusively.

These coherence states must not be collapsed into binary coherent or incoherent classifications, repaired through inference, completed through assumption, or resolved through prioritization. Absence of decisive coherence is preserved as a structural fact, not treated as a failure or deficiency.

By recognizing partial and underdetermined coherence, the architecture avoids forced resolution and prevents systems from projecting certainty, consensus, or uniformity where none is structurally supported.

### 5.3 Coexistence of Coherent and Incoherent States

The coherence assessment architecture permits the coexistence of coherent and incoherent states within the same coherence evaluation.

Encountered records may simultaneously participate in aligned and misaligned relationships depending on which subsets are considered, and the presence of incoherence does not negate the presence of coherence elsewhere, nor does coherence eliminate inconsistency.

No global reconciliation, dominance rule, or resolution strategy is applied, and no subset of records is privileged, suppressed, or selected by virtue of coherence classification. By allowing coexistence without resolution, the invention preserves diagnostic visibility of structural complexity while denying coherence assessment any authority to select, suppress, rank, or decide outcomes.

### 5.4 Declared Coherence Rule Set

Coherence assessment operates under an explicitly declared coherence rule set that is fixed at the time of evaluation. A coherence rule set consists of formally defined structural consistency criteria that determine whether encountered records align or misalign.

The rule set must be: explicitly declared, structurally defined, applied uniformly to all encountered records within a given CSRₖ, and immutable for the duration of that evaluation.

Coherence rules must not be adaptive, learned, optimized, or modified based on outcomes, historical frequency, downstream interpretation, or external feedback within the scope of a single coherence assessment.

### 5.5 Prohibition on Scalar or Probabilistic Coherence Metrics

The coherence assessment architecture must not compute, expose, or assign scalar, probabilistic, weighted, or confidence-based coherence metrics. Coherence classification is categorical and descriptive only.

The architecture is expressly prohibited from: assigning coherence strength values, calculating degrees of consistency, estimating probabilities of alignment, computing distance-to-consistency measures, or exposing any numerical or weighted representation that implies prioritization, ranking, likelihood, or evidentiary strength. Any such scalarization would reintroduce normative or prioritization semantics and is structurally prohibited.

### 6. INCOHERENCE VISIBILITY AND PRESERVATION

### 6.1 Incoherence As First-Class Diagnostic State

The present invention treats incoherence as a first-class diagnostic state. Incoherence represents structural misalignment among encountered records under declared coherence rules and is a legitimate and expected outcome of coherence assessment. Incoherence is not an error, defect, violation, or failure of the system and must be recorded explicitly when present.

Coherence assessment must therefore include explicit categories for incoherence and must surface such states transparently. Incoherence must not be collapsed into generic error states, omitted from outputs, normalized away, or treated as an exceptional condition requiring correction.

By elevating incoherence to a first-class diagnostic state, the invention ensures that misalignment remains visible, inspectable, and preserved rather than hidden, suppressed, or implicitly resolved.

### 6.2 Prohibition on Suppression or Exclusion

The coherence assessment architecture explicitly prohibits suppression, exclusion, removal, or deprioritization of records based on coherence classification. No record may be hidden, filtered, quarantined, deprioritized, made inaccessible, or otherwise constrained as a consequence of being classified as incoherent. Coherence assessment must not alter access, encounterability, routing, eligibility, communicative admissibility, or persistence of any record.

This prohibition applies regardless of the degree, frequency, persistence, or severity of incoherence. Even sustained or extensive incoherence must remain visible as such, and any system behavior that suppresses incoherent material based on coherence classification violates the architectural constraints of the present invention. By denying suppression and exclusion, the invention prevents coherence assessment from becoming a covert moderation, filtering, or enforcement mechanism.

### 6.3 Persistence of Incoherent Records

Records classified as incoherent must persist under the same structural rules as coherent records.

Incoherence must not trigger expiration, decay, attenuation, quarantine, or special handling that results in disappearance, degradation, or reduced accessibility of the record over time.

Coherence assessment produces append-only diagnostic records, such that new coherence assessments may be added at later canonical presents to reflect changes in visibility or structure, while earlier incoherence classifications remain intact and addressable.

By preserving incoherent records and prior assessments as part of the historical record, the invention ensures auditability, temporal fidelity, and resistance to retrospective sanitization of inconsistency.

### 7. PROHIBITION ON TRUTH, RELIABILITY, AND AUTHORITY SEMANTICS

### 7.1 Coherence≠Truth or Correctness

Under the present invention, coherence does not imply truth or correctness.

Coherence assessment classifies internal alignment among encountered records according to declared structural rules and does not establish correspondence to reality, factual accuracy, or correctness of any record. Aligned records may be false, misaligned records may be true, and partial or fragmented coherence may coexist with accurate or incomplete information.

The architecture therefore prohibits interpreting coherence classifications as truth judgments, correctness indicators, or validation signals. Coherence describes how records relate to one another, not whether any record is right.

### 7.2 Denial of Reliability or Trustworthiness Inference

The present invention explicitly denies any inference of reliability, trustworthiness, credibility, or authority from coherence or consistency.

Consistency among records must not be treated as evidence that the records are dependable, authoritative, or worthy of trust, and repetition, mutual reinforcement, or lack of contradiction does not confer credibility. Likewise, inconsistency does not imply unreliability, deception, or bad faith.

By denying reliability and trustworthiness inference, the invention prevents coherence diagnostics from becoming a soft ranking, reputation, or confidence mechanism and preserves the strictly non-normative character of coherence assessment.

### 7.3 No Evidentiary Weight From Consistency

Coherence classifications under the present invention must not be assigned evidentiary weight.

The architecture prohibits using coherence as a proxy for proof, a basis for burden shifting, a criterion for acceptance or rejection, or a justification for prioritization, escalation, or suppression.

Coherence records are descriptive diagnostics only and do not increase or decrease the evidentiary standing of any record, nor may they be combined with other signals to produce evidentiary conclusions within the coherence layer.

By denying evidentiary weight, the invention ensures that coherence assessment remains explanatory rather than persuasive and does not exert influence over interpretation, evaluation, eligibility, or action.

### 8. APPEND-ONLY COHERENCE RECORDS

### 8.1 CSR-Anchored Coherence Entries

Each coherence assessment under the present invention is recorded as a CSR-anchored coherence entry.

A coherence entry is associated with a specific canonical state reference (CSRₖ) and reflects classification of structural alignment and misalignment among records as they are visible at that present only. Coherence entries do not span multiple canonical presents and do not assert continuity, persistence, or evolution beyond their anchoring CSRₖ.

By anchoring coherence entries to CSRₖ, the invention ensures that coherence assessment is present-relative and perspective-bound, such that each classification is a snapshot diagnostic rather than a timeless or global judgment.

### 8.2 No Retroactive Modification or Rewrite

The present invention explicitly prohibits retroactive modification or rewrite of coherence records. Once a coherence entry is recorded for a given CSRₖ, it must not be altered, corrected, reinterpreted, replaced, or superseded based on later information, expanded visibility, reinterpretation, or evaluation.

Subsequent discovery of additional records, changes in access or encounterability, or reinterpretation of structure must not modify prior coherence entries, and earlier assessments must remain intact as records of what was diagnostically visible at the time.

This prohibition preserves historical fidelity, ensuring that coherence history reflects diagnostic observations as they occurred rather than a narrative rewritten by later judgment or authority.

Coherence entries must remain bound to the coherence rule set active at the canonical present (CSRₖ) at which they were created.

Subsequent modification, refinement, or re-declaration of coherence rules must apply prospectively only and must not be used to reinterpret, re-evaluate, or reclassify prior coherence entries under new criteria.

Prior entries remain valid historical diagnostics under the rule set in force at the time of assessment.

### 8.3 New Assessments via New Records Only

Any subsequent coherence assessment must be recorded as a new coherence entry anchored to a later canonical present.

New coherence entries may reference earlier entries for inspection, comparison, or contextual understanding, but must not supersede, invalidate, merge with, or replace them.

Coherence evolution is therefore represented as a sequence of distinct, append-only records, rather than as mutation, correction, or resolution of past assessments.

By enforcing append-only coherence recording, the invention ensures that coherence assessment remains descriptive, non-authoritative, and non-resolutive, preserving coexistence of multiple coherence states across time without collapsing earlier incoherence into later alignment.

### 9. NON-GATING AND NON-INFLUENCE INVARIANTS

### 9.1 No Access, Encounter, or Eligibility Gating

Coherence assessment under the present invention must not gate, alter, condition, or influence access, encounter, or eligibility in any form.

Coherence classifications, including coherent, incoherent, partial, fragmented, or underdetermined states, must not be used to restrict or expand access to records, alter encounterability or routing, affect eligibility for interpretation, evaluation, or action, or condition visibility or persistence of epistemic material.

All access, encounter, and eligibility determinations occur under separate architectural authority and must not consult coherence outputs as gating criteria. Coherence describes alignment among visible records and does not control whether those records may be seen, processed, retained, or acted upon.

### 9.2 No Triggering or Prioritization

The present invention explicitly prohibits triggering, prioritization, ordering, or sequencing based on coherence assessment. Coherence outputs must not trigger alerts, workflows, evaluations, or enforcement actions; must not prioritize some records over others; must not reorder processing sequences; must not suppress, elevate, or deprioritize records based on alignment; and must not influence attention, focus, emphasis, or urgency.

This prohibition applies regardless of the degree, persistence, or severity of coherence or incoherence. Even extreme or sustained inconsistency must not generate automatic responses, and any system behavior that depends on triggering or prioritization must be implemented outside the coherence layer without treating coherence diagnostics as authoritative signals.

Coherence classifications must not influence presentation prominence, ordering of display, visual emphasis, highlighting, alert intensity, notification priority, or attention routing within any user-facing or machine-facing interface. Diagnostic visibility must not be transformed into salience weighting.

### 9.3 Read-Only Diagnostic Outputs

All outputs of the coherence assessment architecture are read-only diagnostic artifacts. Coherence entries may be inspected, audited, logged, visualized, or compared, but must not be written back into upstream or downstream layers and must not modify epistemic boundary records, informational measurements, relational force geometry, routing configuration, continuity state, or evaluative posture.

By enforcing read-only diagnostic outputs, the invention ensures that coherence assessment increases transparency without increasing power, preserving coherence as a tool for understanding structural relationships rather than as a mechanism for enforcing order, resolving disagreement, or controlling outcomes.

### 9.4 Prohibition on Coherence as Feature Signal

Coherence records and classifications must not serve as input features, weighting signals, optimization parameters, training labels, reinforcement signals, or adaptive inputs to any downstream or external system. Coherence diagnostics may be inspected but must not be incorporated into scoring models, ranking engines, recommendation systems, attention-routing systems, learning algorithms, or policy enforcement frameworks. This prohibition applies regardless of whether such incorporation is direct or indirect.

### 10. ONE-WAY DEPENDENCY AND NON-FEEDBACK INVARIANTS

### 10.1 Downstream-Only Consumption

Coherence assessment outputs under the present invention are available only for downstream consumption and must not influence upstream architectural layers.

Coherence entries may be read by downstream interpretive, evaluative, or analytical components for inspection or contextual understanding, but must not be consumed as control inputs. No upstream component, including existence registration, informational measurement, relational force geometry, communicative routing, access determination, or encounter persistence, may consult coherence outputs to modify behavior or state.

This invariant ensures that coherence assessment remains observational rather than operative, such that coherence may be examined and understood without being acted upon implicitly or indirectly.

### 10.2 Prohibition on Upstream Modification

The present invention explicitly prohibits upstream modification of coherence assessment by any process external to the coherence layer.

No component may modify coherence rules based on outcomes, normalize or reconcile incoherence retroactively, alter coherence categories based on evaluation or policy, or feed conclusions back into the coherence mechanism itself.

Any change to coherence criteria, where permitted, must occur only through explicit, externally authorized re-declaration and must apply prospectively, and existing coherence records must remain immutable and are not subject to reinterpretation, correction, or revision.

This prohibition prevents coherence assessment from drifting into adaptive or corrective authority and preserves its role as a stable diagnostic layer.

### 10.3 Determinism and Auditability

All coherence assessments under the present invention are deterministic and auditable.

Given identical visible records, identical declared coherence rules, and identical canonical present anchoring, the system must produce identical coherence entries, and no stochastic behavior, heuristic inference, learning, or adaptive variation is permitted.

Each coherence entry must be fully auditable, with inputs, visibility constraints indicating which records were considered, applied coherence rules, and resulting classifications explicitly inspectable without inference or reconstruction.

By enforcing determinism and auditability, the invention ensures that coherence assessment remains transparent, reproducible, and resistant to authority creep, preserving its function as a descriptive diagnostic within the non-collapse architectural stack.

### 11. ARCHITECTURAL EFFECT AND CLAIM BASIS

### 11.1 Inseparability of Coherence Constraints

The coherence assessment architecture disclosed herein derives its lawful behavior from the inseparable enforcement of its structural constraints. No single constraint, including perspective anchoring, present-state evaluation, incoherence preservation, append-only recording, non-gating behavior, or non-normative classification, produces the claimed architectural effect in isolation.

If coherence is assessed without perspective anchoring, the system collapses into omniscient judgment; if incoherence is not preserved, coherence becomes filtering by exclusion; if append-only recording is removed, coherence history is rewritten to reflect later knowledge; if non-gating constraints are weakened, coherence becomes enforcement; and if normative semantics are permitted, coherence transforms into validity, reliability, or truth judgment.

The architectural effect arises only when all constraints operate together, such that coherence is assessed over what is visible at a given present, classified descriptively without resolution, recorded immutably, and insulated from influence. Removal, weakening, or reordering of any constraint reintroduces the failure modes the invention prevents, including suppression of inconsistency, retroactive truth-making, and covert governance.

Accordingly, the present invention claims the coordinated operation of coherence constraints as a unified architectural whole, rather than any individual classifier, rule set, or data structure viewed in isolation.

### 11.2 Prohibition on Partial or Selective Implementation

The present invention explicitly prohibits partial or selective implementation of the coherence assessment architecture.

Selective implementation includes configurations that expose coherence while suppressing incoherent records, classify consistency while inferring reliability or credibility, preserve incoherence while allowing it to gate access or priority, anchor coherence to the present while rewriting past assessments, or deny normative semantics in principle while enabling enforcement in practice.

Such implementations recreate the surface appearance of neutral coherence diagnostics while restoring authority through alternate pathways. The invention therefore defines its scope at the level of architectural effect, not at the level of individual classifiers, data structures, reporting mechanisms, or presentation formats.

Any system that achieves substantially the same effect, namely exposing consistency and inconsistency without resolving, suppressing, prioritizing, or enforcing them, falls within the scope of the present claims regardless of differences in terminology, sequencing, or execution strategy.

### 11.3 Inconsistency Without Resolution as System-Level Effect

The system-level contribution of the present invention is inconsistency without resolution. Inconsistency without resolution is defined as the ability to expose misalignment, contradiction, fragmentation, or underdetermination among epistemic records without attempting to reconcile, suppress, prioritize, or decide between them, such that coherence assessment explains how records relate without selecting which record should prevail.

By enforcing non-normative classification, incoherence visibility, append-only history, and non-influence invariants, the architecture ensures that coherence diagnostics increase transparency without exercising power, preserving misalignment as visible structure rather than erasing, correcting, or weaponizing it.

This effect, namely visibility of inconsistency without resolution, distinguishes the present invention from moderation systems, truth engines, reliability scorers, and consensus mechanisms that convert coherence into authority, and enables understanding of structural alignment while preserving autonomy, auditability, and neutrality across the epistemic stack.

Any system achieving substantially the same architectural effect of exposing structural inconsistency without resolution, suppression, prioritization, ranking, enforcement, or authority acquisition—regardless of terminology, sequencing, internal data structures, or implementation strategy—falls within the scope of the present invention.

### 12. CLOSING STATEMENT

The present invention establishes a coherence assessment architecture that makes alignment and misalignment visible without resolving, suppressing, prioritizing, or enforcing them.

By evaluating coherence as a present-anchored, perspective-bound diagnostic over encountered structure, the architecture records consistency and inconsistency as descriptive structural states rather than as judgments of truth, validity, correctness, reliability, or evidentiary weight. Coherence does not confer credibility, authority, or priority, and incoherence does not justify exclusion, correction, or dismissal. Both remain first-class, inspectable outcomes.

Crucially, the architecture denies all pathways by which coherence typically becomes control. Coherence records are append-only, immutable, and read-only, and do not gate access, alter encounterability, trigger action, prioritize processing, condition eligibility, or influence downstream execution. No downstream process may feed back to modify coherence criteria or rewrite coherence history.

Coherence assessment therefore explains structure as it appears at a given present, without rewriting the past, anticipating future resolution, or deciding outcomes. Diagnostic visibility increases without introducing pressure, authority, or enforcement.

The architectural effect protected by the present invention arises from the inseparable enforcement of these constraints. Partial or selective implementation reintroduces authority through alternate routes, collapsing diagnostics into moderation, ranking, or truth-making. Accordingly, the protected subject matter is not a particular classifier, taxonomy, or schema, but the system-level behavior produced by inconsistency without resolution.

By exposing coherence without authority, the invention provides a neutral diagnostic substrate suitable for audit-critical, autonomy-preserving, and governance-sensitive systems in which understanding structural alignment must not entail the power to decide, suppress, or govern.

### 14. BRIEF SUMMARY

The present invention provides a coherence assessment architecture that exposes structural alignment and misalignment without resolving, suppressing, prioritizing, or enforcing outcomes.

The architecture evaluates coherence as a descriptive diagnostic over encountered epistemic records, anchored to a canonical present and constrained by agent-relative visibility. Coherence classifications are categorical and non-normative and support aligned, misaligned, partial, fragmented, and underdetermined states, including coexistence of coherent and incoherent relationships within a single assessment.

Coherence assessment does not imply truth, validity, correctness, reliability, credibility, or evidentiary strength. Incoherent material remains visible and persists under the same existence, access, and encounter rules as coherent material, and coherence records are append-only, immutable, and read-only.

Coherence records do not gate access, alter encounterability, condition eligibility, trigger action, prioritize processing, or influence downstream execution. No upstream or downstream process may feed back to modify coherence rules or rewrite coherence history.

By enforcing perspective anchoring, incoherence preservation, non-gating, and non-feedback invariants, the invention produces a system-level effect of inconsistency without resolution, increasing diagnostic transparency without conferring authority. The architecture provides a neutral, audit-safe coherence layer suitable for autonomy-preserving and governance-sensitive systems in which understanding alignment must not become governance.

1. A computer-implemented coherence assessment architecture for a multi-record system, comprising a coherence assessment mechanism configured to classify structural alignment and misalignment among encountered epistemic records and a coherence record that records the classification as a diagnostic state, wherein the coherence assessment is descriptive, non-normative, and non-decisional and does not assert truth, validity, reliability, credibility, or consequence.

2. The architecture of claim 1, wherein coherence classification describes internal consistency among visible records without resolving contradictions, suppressing inconsistency, prioritizing any record, or selecting outcomes.

3. The architecture of claim 1, wherein coherence assessment is anchored to a canonical present (CSRₖ) and reflects alignment and misalignment as visible at that present only.

4. The architecture of claim 1, wherein coherence assessment is perspective-bound and limited to records that are encounterable or encountered by an assessing agent.

5. The architecture of claim 1, wherein coherence assessment is prohibited from assuming global, complete, or omniscient visibility of records.

6. The architecture of claim 1, wherein coherence classifications include categorical states for alignment, misalignment, partial coherence, fragmented coherence, and underdetermined coherence.

7. The architecture of claim 6, wherein coherent and incoherent states are permitted to coexist within a single coherence assessment without reconciliation or dominance.

8. The architecture of claim 1, wherein incoherence is treated as a first-class diagnostic state rather than as an error, defect, or failure.

9. The architecture of claim 1, wherein coherence classification does not imply truth, correctness, factual accuracy, or correspondence to reality.

10. The architecture of claim 1, wherein coherence classification is explicitly denied use as an indicator of reliability, trustworthiness, credibility, or evidentiary strength.

11. The architecture of claim 1, wherein coherence classification carries no normative, moral, evaluative, prescriptive, or authoritative semantics.

12. The architecture of claim 1, wherein records classified as incoherent are not suppressed, filtered, excluded, quarantined, or deprioritized as a result of coherence assessment.

13. The architecture of claim 12, wherein incoherent records persist under the same access, encounter, and existence rules as coherent records.

14. The architecture of claim 1, wherein coherence records are append-only and immutable after formation.

15. The architecture of claim 1, wherein subsequent coherence assessments are recorded as new coherence records rather than as modifications or replacements of prior records.

16. The architecture of claim 1, wherein coherence records are prohibited from gating access, altering encounterability, conditioning eligibility, triggering action, prioritizing processing, or influencing downstream execution.

17. The architecture of claim 1, wherein coherence records are read-only diagnostic outputs.

18. The architecture of claim 1, wherein no upstream or downstream process may modify coherence criteria, normalize incoherence, or alter coherence records after formation.

19. The architecture of claim 1, wherein coherence assessment is deterministic and auditable such that identical visible records, coherence rules, and present anchoring produce identical coherence records.

20. The architecture of claim 1, wherein coordinated enforcement of perspective anchoring, incoherence visibility, append-only recording, and non-gating produces a system-level effect of inconsistency without resolution.

21. The architecture of claim 20, wherein partial or selective implementation of coherence assessment constraints is structurally prohibited because removal or weakening of any constraint reintroduces suppression, prioritization, retroactive judgment, or authority.

22. The architecture of claim 1, wherein the coherence assessment layer is structurally prohibited from acquiring decision, prioritization, enforcement, filtering, or governance authority through integration with any other architectural layer.

23. A method for coherence assessment in a computational system, comprising assessing structural alignment and misalignment among encountered records at a present, recording the assessment as a diagnostic coherence record, and prohibiting use of the assessment to resolve, suppress, prioritize, or enforce outcomes.

24. A non-transitory computer-readable medium storing instructions that, when executed by one or more processors, cause the processors to implement the coherence assessment architecture of any of claims 1 through 21.

24. The method of claim 22, wherein assessing structural alignment and misalignment is anchored to a canonical present (CSRₖ) such that the assessment reflects only records encounterable at that present.

25. The method of claim 22, wherein incoherent records remain visible and are not suppressed, filtered, excluded, deprioritized, or reconciled as a result of the assessment.

26. The method of claim 22, further comprising recording each coherence assessment as an append-only coherence record that is immutable after formation.

27. The method of claim 22, wherein the assessment does not assign scalar, probabilistic, weighted, confidence-based, or ranking metrics to structural alignment or misalignment.

28. The method of claim 22, wherein the assessment is prohibited from gating access, altering encounterability, conditioning eligibility, triggering execution, prioritizing processing, or influencing downstream system behavior.

29. The method of claim 22, wherein identical encountered records, coherence rules, and canonical present anchoring produce identical coherence records.

30. The computer-readable medium of claim 23, wherein the instructions cause coherence assessments to be anchored to a canonical present (CSRₖ) and limited to records encounterable at that present.

31. The computer-readable medium of claim 23, wherein the instructions cause incoherent records to remain visible and persist under the same access and encounter rules as coherent records.

32. The computer-readable medium of claim 23, wherein the instructions cause coherence records to be stored in an append-only and immutable form.

33. The computer-readable medium of claim 23, wherein the instructions prohibit assignment of scalar, probabilistic, ranking, prioritization, or confidence metrics to coherence classifications.

34. The computer-readable medium of claim 23, wherein the instructions prevent coherence records from being used to gate access, alter encounterability, prioritize processing, trigger execution, or influence control flow.
